(19) United States
(12) Patent Application Publication
(10) Pub. No.: US 2019/0172169 A1
(43) Pub. Date: Jun. 6, 2019

(54) System and Method of Predicting Freight Rates

(71) Applicant: Cory Margand, E Falmouth, MA (US)

(72) Inventor: Cory Margand, E Falmouth, MA (US)

(21) Appl. No.: 15/831,891

(22) Filed: Dec. 5, 2017

(51) Int. Cl. G06Q 50/28; G06Q 30/02

(52) U.S. Cl. CPC G06Q 50/28; G06Q 30/0202

(57) ABSTRACT

The invention introduces a system and method of predicting freight rates. This method allows for purchasers of freight to get many different options of the current market price. It also allows the purchaser to buy that freight and book the shipment. So, the platform is collecting valuable proprietary data related to rates and shipping in general. The present invention allows those purchasing freight (or have financial interest e.g. financial institutions) to obtain future predictions of rates. The present invention enables those purchasing freight or others to better optimize their decision process.

The platform will utilize the platform's data plus other inputs as needed (see inputs to predictive rates) to provide visibility to future rates and optimize the shipper's freight spend. With this information shippers, can now make data driven decisions on when to procure based off the current market and the future rather than only one the current market.

### FIELD OF THE INVENTION

The present invention relates generally to pricing and shipping. More specifically, the present invention is a system and method of predicting and providing future domestic and international rates specific to the shipping industry.

### BACKGROUND OF THE INVENTION

Shipping is a process in which one or more objects are transported in vehicles from a place of origin to a select destination. Carriers, brokers, forwarders, non-vessel operating common carriers (NVOCC's) are parties that can sell freight to shippers. Brokers, forwarders, and NVOCC's buy freight from carriers and re-sell them to shippers. Today, current pricing strategies in the freight industry are becoming more automated. However, for a shipper it is only possible to obtain today's current market price with no visibility to what the price might be at any given moment in the future. This causes major challenges as the company purchasing freight has no guidance on whether it's best to purchase now or wait.

It is therefore an objective of the present invention to introduce a system and method of predicting freight rates. The platform that will be discussed below allows for purchasers of freight to get many different options of the current market price. It also allows the purchaser to buy that freight and book the shipment. So, the platform is collecting valuable proprietary data related to rates and shipping in general. The present invention allows those purchasing freight (or have financial interest e.g. financial institutions) to obtain future predictions of rates. The present invention enables those purchasing freight or others to better optimize their decision process. The present invention will be, but not limited, provided in 2 ways:
1. Shippers come on to the freight platform and post their shipment or get an instant rate current market rate.
   a. In both above cases, along with the current market rate the platform will provide future rates.
2. Future rates could be provided and sold to interested parties as a separate product.
3. Offer the solution via API (Application Programming Interface) for other software and hardware solutions to integrate.

Shippers come on to the platform, enter their shipment details including: mode of transport, origin, destination, etc. Forwarders are notified (see current process of shippers procuring freight on the platform) and provide their current market rate. As mentioned above, the present invention is introducing a system for providing predictive freight rates. The platform will utilize the platform's data plus other inputs as needed (see inputs to predictive rates) to provide visibility to future rates and optimize the shipper's freight spend. With this information shippers, can now make data driven decisions on when to procure based off the current market and the future rather than only one the current market.

The present invention is not limited to the technology in which it's being delivered and is relevant but not limited to web based and mobile applications. The present invention delivers: infrastructure as a service (IaaS), software as a service (SaaS), and a platform as a service (PaaS), on premise hardware, including but not limited to servers, data centers, smartphones, personal computers, netbooks, tablets, and more.

### BRIEF DESCRIPTION OF THE DRAWINGS

FIG. 1 shows the relationship between carrier, forwarder, and shipper. The carrier sells capacity to a forwarder/NVOCC and they in turn resell that capacity to a shipper;

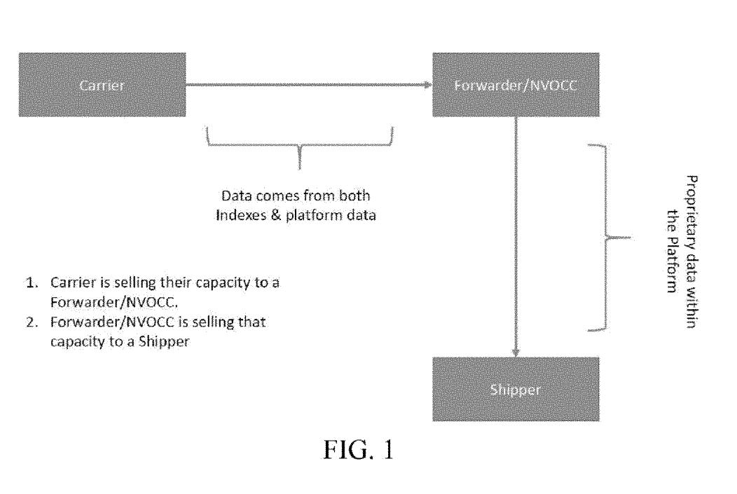

FIG. 2 shows from a high-level view how that platform operates;

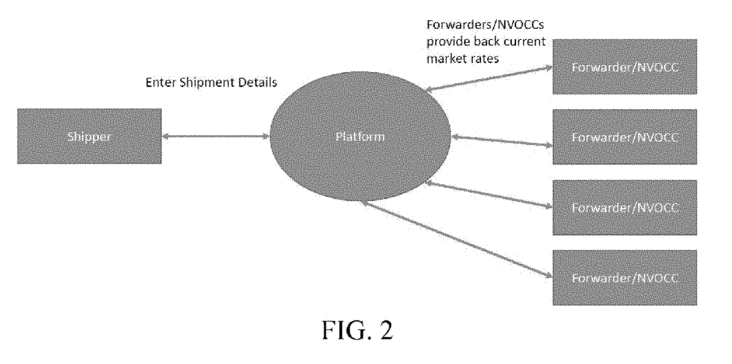

FIG. 3 details the many different inputs that are being utilized in order make predictions on future rates;

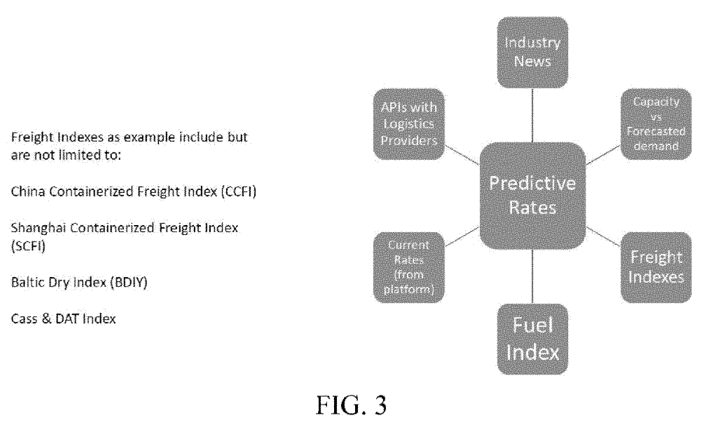

FIG. 4 shows the current user experience;

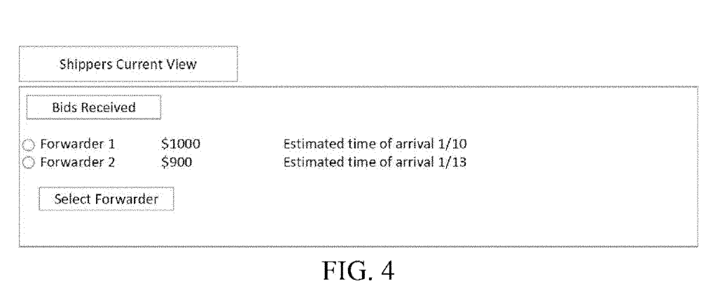

FIG. 5 details out how the platform will change potentially (not limited to) to enable shippers, customers, and other digital solutions to make better decisions;

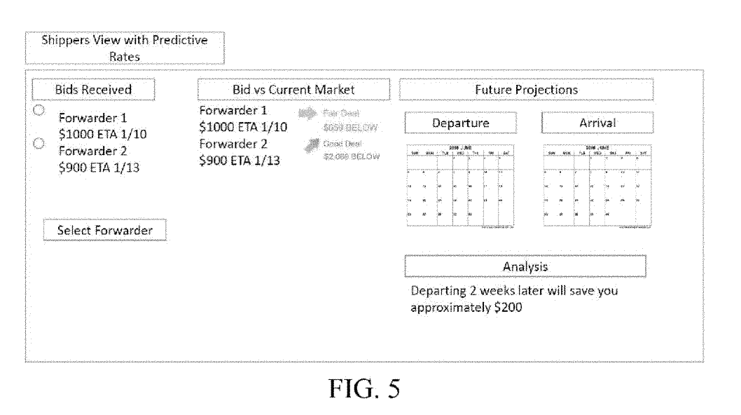

FIG. 6 shows an example of an alternative solution that the present invention could be used for. In other words, those that aren't shipping anything right now may be interested in just seeing the rates for financial or long term contract reasons;

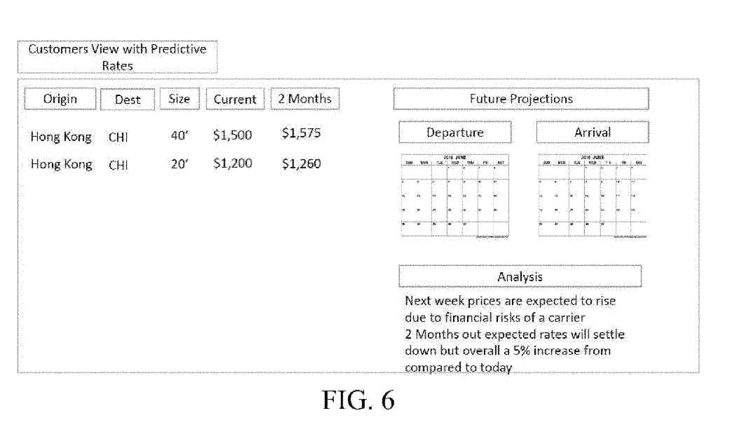

FIG. 7 details out how the platform uses the data sets/inputs to calculate rates; and

FIG. 8 shows the end to end system process.

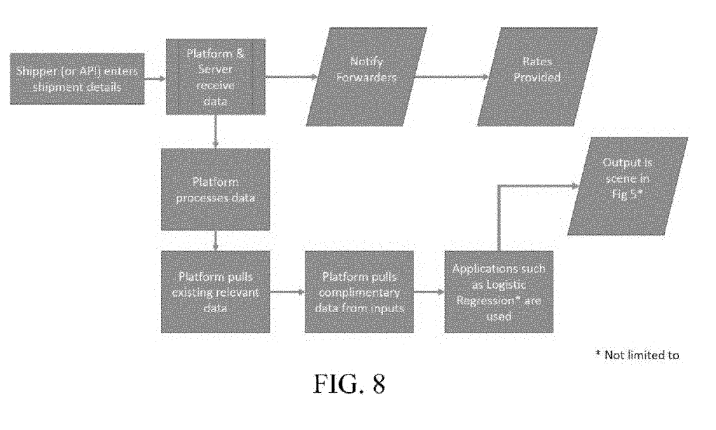

### DETAIL DESCRIPTIONS OF THE INVENTION

All illustrations of the drawings are for the purpose of describing selected versions of the present invention and are not intended to limit the scope of the present invention.

In view of the aforementioned problem(s), the present invention is a system and method of predicting freight rates. The present invention allows shippers and others to obtain rates from logistics providers and compare them to the forecasted pricing through the use of a shipping application. Before explaining at least one embodiment of the present invention in detail, it is to be understood that the system is not limited in its application to the details of the components and arrangements as described or illustrated. The present invention is capable of other embodiments and of being utilized and carried out in various ways. It is also to be understood that the phrasing and terminology employed herein are for the purpose of description and should not be regarded as limiting. The present invention is primarily used to provide future freight rates shipping, utilizing freight and other transportation vehicles, but the system may be applied to many other settings, situations, and scenarios.

In the preferred embodiment, the present invention comprises a method which allows shippers to obtain freight pricing, through the use of a shipping application and a server (web, virtual, open source, etc.). This method will be explained further on. The shipping application may be accessed electronically on mobile devices (smartphones, tablets, smart watches, etc.), online via a personal computer, and more. The shipping application is utilized by carriers, forwarders, brokers who are parties in control of freight and other transportation vehicles used for shipping. Each transportation vehicle holds a plurality of containers, cartons, pallets, crates, etc. Shippers are parties who wish to ship or transport one or more objects from a place of origin (starting point) to a destination of their choice. Shippers log onto the shipping application to book their freight shipments directly with the carriers of their choice. The place of origin may be from a domestic location or a “port.” The destination may be a domestic location or a port location as well. Domestic locations may be houses, factories, office buildings, and so forth, while port locations generally refer to locations where objects are directly and internationally imported to or exported from, whether it be a coast, shore, harbor, airport, etc. In the preferred embodiment of the present invention, the shipping application is used to provide instant freight pricing for port to port shipping, door to port shipping, port to door shipping, and door to door shipping. Port to port shipping refers to international shipping, where one or more objects are shipped from a first port to a second port, where the first port is the origin (starting location), being a port located in a first country. The second port is the destination (end location), being a port located in a second country. Door to port shipping refers to international shipping, where one or more objects are shipped from a first domestic location, to a first port, and finally to a second port, where the first domestic location is the origin, being in the same country as the first port, and where the second port is the destination, being in a second country. Port to door shipping refers to international shipping, where one or more 4 objects are shipped from a first port, to a second port, and finally to a second domestic location, where the first port is the origin and the second port is in the same country as the second domestic location, which is the destination. Door to door shipping refers to either: (A) international shipping, where one or more objects are shipped from first domestic location, to a first port, then to a second port, and finally a second domestic location, where the first domestic location is the origin, being located in the same country as the first port, and where the second domestic location is the destination, being located in the same country as the second port; or (B) domestic shipping, where one or more objects are shipped from a first domestic location to a second domestic location, where the first domestic location is the origin and the second domestic location is the destination, with the first domestic location being located in the same country as the second domestic location. In the preferred embodiment of the present invention, the shipping application/platform in combination with data science approaches such as logistic regression pulls external and internal data and can provide predictions for future prices by applying weights to the importance of the inputs and determining the probability of certain events occurring that could cause rates to increase or decrease.

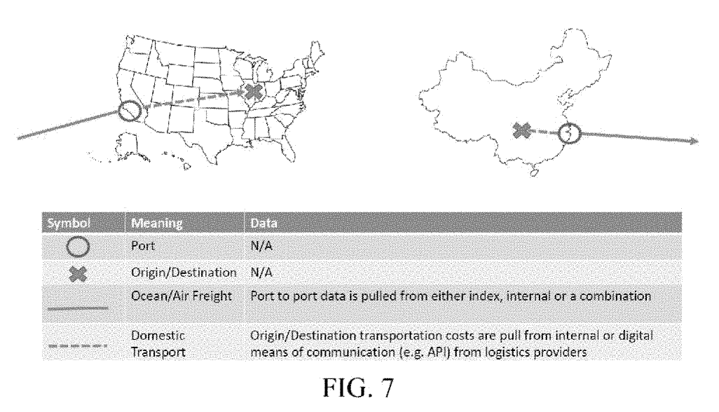

Example (see FIG. 7):

Origin: Dongguan, China

Destination: Chicago, Ill.

Mode: Ocean 40′ Container

Service: Door to Door

In the above example, the platform will pull current and historical rates from both internal and external data for the port closest to Dongguan (Shenzhen) and the closest port utilized for Chicago (Los Angeles, Long Beach). The platform will then pull either internal domestic rates for the origin and domestic transportation. Origin transportation is the cost of moving the shipment from Dongguan to Shenzhen and destination from Los Angeles to Chicago. The platform now knows exactly what the current price of that shipment will be. The platform will now calculate (as discussed above) the predicted future rates based on any given time line either fixed or provided by the user. Together with the current prices and data (application/platform), historical indexes, the present invention can provide future predictions back to the user to make educated decisions on when to procure freight. It is to be understood that this is just a brief example and that other methods may be utilized.
Previously, this document has been related to forwarders selling to shippers. However, this method of pricing may be applied to carriers both international and domestic with regards to their own assets. In the preferred embodiment of the present invention carriers are parties who are parties in control of freight and own transportation vehicles used for shipping whether domestic or international. Carriers may choose to utilize this system to sell more efficiently to forwarders, NVOCCs, and shippers. This

1. This is a system and method of predicting freight rates which may be comprised of any combination of the below:
a. International ocean or air freight
b. Domestic trucking and/or drayage
c. Rail.

2. This system may use data available publicly or data purchased from other providers to transform the output into freight rate predictions about the future.

3. This system may also use internal data either stand alone or in combination with claim 2 to accomplish predictions of freight rates.

4. This method may either provide a broad indication of whether the market in the future will stay stagnant, increase, decrease, or it may provide rates at a specific predicted number.
